(19) United States
(12) Patent Application Publication
(10) Pub. No.: US 2021/0016325 A1
(43) Pub. Date: Jan. 21, 2021

(54) TESTING APPARATUS

(71) Applicant: TRIPLE WIN TECHNOLOGY(SHENZHEN) CO.LTD., Shenzhen (CN)

(72) Inventor: YING-QUAN ZHAO, Shenzhen (CN)

(21) Appl. No.: 16/533,913

(22) Filed: Aug. 7, 2019

(30) Foreign Application Priority Data
Jul. 16, 2019 (CN) 201921118635.6

(51) Int. Cl. B07C 5/36; B25J 15/00

(52) U.S. Cl. CPC B07C 5/36; B07C 2501/0063; B25J 15/0052

(57) ABSTRACT

A testing apparatus includes a first testing module, a pipeline, a grabbing mechanism, and a second testing module. The pipeline includes an input line and an output line arranged in parallel. The grabbing mechanism is arranged perpendicularly between the input line and the output line. The first testing module and the second testing module are arranged below the grabbing mechanism. The grabbing mechanism grabs a workpiece from the input line and places the workpiece at the first testing module or the second testing module for testing the workpiece. The grabbing mechanism grabs the workpiece from the first testing module or the second testing module and places the workpiece on the output line for outputting the workpiece.

### FIELD

The subject matter herein generally relates to testing apparatuses, and more particularly to a testing apparatus for testing a plurality of workpieces.

### BACKGROUND

Generally, a workpiece goes through multiple inspection processes during manufacture. The inspection processes are generally difficult to combine and require large manpower to implement.

### BRIEF DESCRIPTION OF THE DRAWINGS

Implementations of the present disclosure will now be described, by way of embodiments, with reference to the attached figures.

FIG. 1 is a top view schematic diagram of an embodiment of a testing apparatus.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

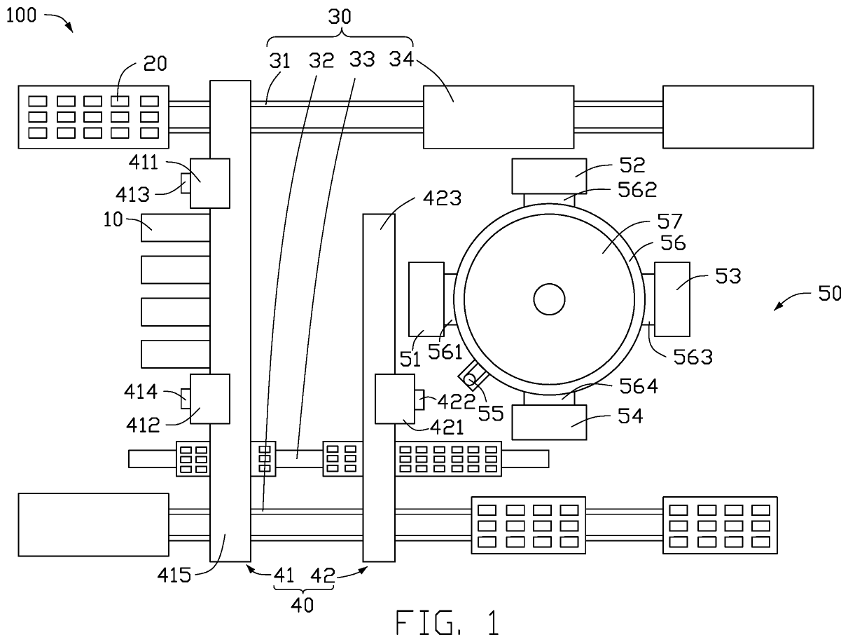

FIG. 1 shows an embodiment of a testing apparatus 100 for testing a workpiece 20. The testing apparatus 100 includes at least one first testing module 10, a pipeline 30, a grabbing mechanism 40, and a second testing module 50. The pipeline 30 includes an input line 31, an output line 32, a waste storage line 33, and a plurality of transport trays 34. The grabbing mechanism 40 includes a first transport track 41 and a second transport track 42. The second testing module 50 includes a placement platform 51, a first testing device 52, a second testing device 53, a third testing device 54, a standard light source calibration member 55, a turntable 56, and a protective cover 57.

The input line 31, the output line 32, and the waste storage line 33 are arranged in parallel. The at least one first testing module 10, the grabbing mechanism 40, and the second testing module 50 are disposed between the input line 31 and the output line 32. The grabbing mechanism 40 is disposed substantially perpendicular to the input line 31, the output line 32, and the waste storage line 33. The first testing module 10 and the second testing module 50 are respectively disposed on opposite sides of the grabbing mechanism 40.

The transport trays 34 are used for accommodating the workpieces 20. The input line 31, the output line 32, and the waste storage line 33 are used for conveying the transport trays 34 and the workpieces 20. A conveying direction of the input line 31 is the same as a conveying direction of the output line 32.

The first transport track 41 includes a first sliding rail 415, a first linear motor moving module 411, a second linear motor moving module 412, a first grabber 413, and a second grabber 414. The first linear motor moving module 411 and the second linear motor moving module 412 are movably disposed on the first sliding rail 415. The first grabber 413 is mounted to the first linear motor moving module 411, and the second grabber 414 is mounted to the second linear motor moving module 412. The first transport track 41 is disposed perpendicularly across the input line 31, the output line 32, and the waste storage line 33. The at least one first testing module 10 is disposed on a side of the first transport track 41 facing away from a conveying direction of the input line 31. The first grabber 413 is disposed corresponding to the input line 31, and the second grabber 414 is disposed corresponding to the output line 32.

In one embodiment, the transport trays 34 transport the workpieces 20 to the first transport track 41 along the input line 31. The first grabber 413 grabs the workpieces 20 from the transport trays 34, and empty transport trays 34 are returned to a beginning of the input line 31 to load more workpieces 20. The first linear motor moving module 411 moves the first grabber 413 to the at least one first testing module 10 for testing. If the workpiece 20 is qualified by the at least one first testing module 10, the second grabber 414 grabs the qualified workpiece 20, the second linear motor moving module 412 moves the second grabber 414 to the output line 32, and the second grabber 414 places the qualified workpiece 20 on the transport tray 34 of the output line 32. If the workpiece 20 is unqualified by the at least one first testing module 10, the second linear motor moving module 412 moves the second grabber 414 to the waste storage line 33, and the second grabber 414 places the unqualified workpiece 20 on the transport tray 34 of the waste storage line 33.

The transport tray 34 on the output line 32 transports the qualified workpiece 20 to the second transport track 42.

The second transport track 42 is coupled to the output line 32 and the second testing module 50. The second transport track 42 includes a second sliding rail 423, a third linear motor moving module 421, and a third grabber 422. The third linear motor moving module 421 is movably disposed on the second sliding rail 423, and the third grabber 422 is mounted to the third linear motor moving module 421. The third linear motor moving module 421 moves the third grabber 422 along the second transport track 42.

After the qualified workpieces 20 are transported to the second transport track 42, the third grabber 422 randomly grabs a workpiece 20 for sampling, and the third linear motor moving module 421 moves the third grabber 422 to the second testing module 50.

The turntable 56 of the second testing module 50 is rotationally mounted. The third grabber 422 places the workpiece 20 on the turntable 56 for further inspection. The turntable 56 includes a first clamp 561, a second clamp 562, a third clamp 563, and a fourth clamp 564. The first clamp 561, the second clamp 562, the third clamp 563, and the fourth clamp 564 are spaced 90 degrees apart on the turntable 56 and rotate with the turntable 56. The placement platform 51, the first testing device 52, the second testing device 53, and the third testing device 54 are spaced 90 degrees apart on the turntable 56. The placement platform 51, the first testing device 52, the second testing device 53, and the third testing device 54 are fixedly disposed. The standard light source calibration member 55 is fixedly mounted on the turntable 56 for light source calibration. A protective cover 57 is disposed above the turntable 56 to prevent reflection.

In one embodiment, the third grabber 422 places a first workpiece 20 in the first clamp 561 at the placement platform 51, then the turntable 56 rotates 90 degrees to position the first clamp 561 at the first testing device 52 for testing and position the fourth clamp 564 at the placement platform 51. Then, the third grabber 422 places a second workpiece 20 in the fourth clamp 564, and the turntable 56 is rotated 90 degrees to position the first clamp 561 at the second testing device 53 for testing, position the fourth clamp 564 at the first testing device 52 for testing, and position the third clamp 563 at the placement platform 51. Then, the third grabber 422 places a third workpiece 20 in the third clamp 563, and the turntable 56 is rotated 90 degrees to position the first clamp 561 at the third testing device 54 for testing, position the fourth clamp 564 at the second testing device 53 for testing, position the third clamp 563 at the first testing device 52 for testing, and position the second clamp 562 at the placement platform 51. Then, the third grabber 422 places a fourth workpiece 20 in the second clamp 562, and the turntable 56 is rotated 90 degrees to position the first clamp 561 at the placement platform 51, position the fourth clamp 564 at the third testing device 54 for testing, position the third clamp 563 at the second testing device 53 for testing, and position the second clamp 562 at the first testing device 52 for testing. Thus, the third grabber 422 continuously places a new workpiece 20 in the first clamp 561, the fourth clamp 564, the third clamp 563, and the second clamp 562 in sequence at the placement platform 51 after each 90 degree rotation.

After the workpiece 20 has been tested by the first testing device 52, the second testing device 53, and the third testing device 54, if the workpiece 20 is qualified, the third grabber 422 grabs the workpiece 20, the third linear motor moving module 421 moves the third grabber 422 to the output line 32, the third grabber 422 places the qualified workpiece 20 on the transport tray 34 of the output line 32, and the transport tray 34 transports the qualified workpiece 20 out of the testing apparatus 100 through the output line 32. If the workpiece 20 is unqualified, the third linear motor moving module 421 moves the third grabber 422 to the waste storage line 33, and the third grabber 422 places the unqualified workpiece 20 on the transport tray 34 of the waste storage line 33 for recycling.

Compared with the related art, the testing apparatus 100 can automatically test a plurality of workpieces 20 by the at least one first testing module 10 and the second testing module 50. The pipeline 30 can automatically input, output, and recycle the workpieces 20, thereby improving efficiency and automation of inspection of the workpieces 20 and reducing labor costs.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A testing apparatus comprising:
a first testing module;
a pipeline;
a grabbing mechanism; and
a second testing module; wherein:
the pipeline comprises an input line and an output line arranged in parallel;
the grabbing mechanism is arranged perpendicularly between the input line and the output line;
the first testing module and the second testing module are arranged below the grabbing mechanism;
the grabbing mechanism grabs a workpiece from the input line and places the workpiece at the first testing module or the second testing module for testing the workpiece;
the grabbing mechanism grabs the workpiece from the first testing module or the second testing module and places the workpiece on the output line for outputting the workpiece.

2. The testing apparatus of claim 1, wherein:
the pipeline further comprises a waste storage line arranged parallel and adjacent to the output line.

3. The testing apparatus of claim 1, wherein:
the grabbing mechanism comprises a first transport track arranged perpendicularly between the input line and the output line and adjacent to the first testing module;
the first transport track comprises a first sliding rail, a first linear motor moving module, a second linear motor moving module, a first grabber, and a second grabber;
the first linear motor moving module and the second linear motor moving module are movably disposed on the first sliding rail;
the first grabber is mounted to the first linear motor moving module, and the second grabber is mounted to the second linear motor moving module.

4. The testing apparatus of claim 1, wherein:
the grabbing mechanism comprises a second transport track coupled to the output line and the second testing module;
the second transport track comprises a second sliding rail, a third linear motor moving module, and a third grabber;
the third linear motor moving module is movable disposed on the second sliding rail;
the third grabber is mounted to the third linear motor moving module.

5. The testing apparatus of claim 1, wherein:
the second testing module comprises a turntable and a plurality of clamps;
each of the plurality of clamps clamps one workpiece; and
the plurality of clamps are equally spaced apart and fixedly mounted on the turntable.

6. The testing apparatus of claim 5, wherein:
the second testing module further comprises a plurality of testing devices; and
the plurality of testing devices are equally spaced apart around the turntable for testing the workpieces.

7. The testing apparatus of claim 6, wherein:
the plurality of clamps and the plurality of testing devices are equally spaced apart at a same angle;
each rotation of the turntable at the same angle causes each clamp to move from one of the plurality of testing devices to a next one of the plurality of testing devices.

8. The testing apparatus of claim 6, wherein:
the second testing module further comprises a protective cover disposed above the turntable for covering the plurality of clamps.

9. A testing apparatus for testing a plurality of workpieces, the testing apparatus comprising:
a first testing module;
a pipeline;
a grabbing mechanism; and
a second testing module; wherein:
the pipeline comprises an input line and an output line arranged in parallel;
the grabbing mechanism is arranged perpendicularly between the input line and the output line;
the first testing module and the second testing module are arranged below the grabbing mechanism;
the grabbing mechanism grabs a workpiece from the input line and places the workpiece at the first testing module for testing the workpiece;
if the workpiece is qualified by the first testing module, the grabbing mechanism grabs the qualified workpiece from the first testing module and places the qualified workpiece at the second testing module for testing; and
if the workpiece is qualified by the second testing module, the grabbing mechanism grabs the qualified workpiece from the second testing module and places the qualified workpiece on the output line for outputting the workpiece.

10. The testing apparatus of claim 9, wherein:
the input line and the output line comprises a plurality of transport trays;
the workpieces are loaded onto the transport trays of the input line;
after the workpieces are qualified by the first testing module, the grabbing mechanism places the qualified workpieces onto the transport trays of the output line; and
the grabbing mechanism grabs the workpieces from the transport trays of the output line and places the workpieces at the second testing module for testing.

11. The testing apparatus of claim 10, wherein:
the workpieces on the output line are randomly selected by the grabbing mechanism for testing by the second testing module; and
the workpieces qualified by the second testing module are placed back on the transport trays of the output line for outputting the qualified workpieces.

12. The testing apparatus of claim 11, wherein:
the pipeline further comprises a waste storage line; and
if the workpiece is unqualified by the first testing module or the second testing module, the grabbing mechanism places the workpiece on a transport tray of the waste storage line for recycling the workpiece.
